(19) United States
(12) Patent Application Publication
(10) Pub. No.: US 2008/0125255 A1
(43) Pub. Date: May 29, 2008

(54) Drivetrain for utility vehicle

(76) Inventor: Paul Robert Heide, Norfolk, VA (US)

Correspondence Address: THE LAW OFFICE OF RANDALL T. ERICKSON, P.C., 1749 S. NAPERVILLE ROAD, SUITE 202, WHEATON, IL, 60187, US

(21) Appl. No.: 11/975,720

(22) Filed: Oct. 19, 2007

Related U.S. Application Data
(63) Continuation of application No. 11/475,730, filed on Jun. 27, 2006, now abandoned.
Application No. 11/475,730 is a continuation of application No. 10/616,828, filed on Jul. 10, 2003, now abandoned.

(51) Int. Cl. F16H 55/56

(52) U.S. Cl. 474/8

(57) ABSTRACT

A utility vehicle drivetrain includes an engine driving a continuously variable transmission (CVT) that drives a transaxle that drives at least one wheel. The continuously variable transmission has a CVT turn ratio defined as an engine output rotary speed into the CVT divided by a CVT output rotary speed into the transaxle. The transaxle has a transaxle turn ratio defined as the CVT output rotary speed divided by a transaxle output rotary speed to the at least one wheel. The transaxle turn ratio can be greater than five times the maximum CVT turn ratio. The transaxle turn ratio can be greater than twenty times the minimum CVT turn ratio. The transaxle turn ratio can be greater than 17.

This application is a continuation of U.S. Ser. No. 11/475,730 filed Jun. 27, 2006, which is a continuation of U.S. Ser. No. 10/616,828, filed Jul. 10, 2003, now abandoned, and claims the benefit of U.S. Provisional Application Ser. No. 60/440,215, filed Jan. 15, 2003.

### TECHNICAL FIELD OF THE INVENTION

The present invention relates to drivetrains for utility vehicles. Particularly, the invention relates to continuously variable transmissions and transaxles for small utility carts.

### BACKGROUND OF THE INVENTION

Small utility carts are known such as a John Deere GATOR® utility vehicle. Such vehicles are particularly effective to transport people and cargo short distances at relatively low speeds. Such vehicles are routinely used as golf carts, neighborhood vehicles, work vehicles or plant maintenance vehicles.

The John Deere GATOR® 4×2 vehicle includes an operator area, a rear mounted engine and a transaxle operatively connected to at least one wheel to drive the vehicle. Between the engine output shaft and the transaxle input shaft is arranged a continuously variable transmission that transfers power from the engine output shaft to the transaxle input shaft. The continuously variable transmission includes a primary clutch in the form of a first split sheave mounted for rotation with the engine output shaft, and a secondary clutch in the form of a second split sheave mounted for rotation with the transaxle input shaft. A drive belt is wrapped around the two sheaves. Both first and second sheaves have V-shaped annular races that are defined by a fixed face and a movable face. The width of each race determines the circumference that the belt wraps around the respective sheave.

The variable clutch system is speed and load sensitive. The primary and secondary clutches work together, automatically up-shifting and down-shifting. The shifting changes the ratio between the clutches allowing the engine to operate at optimum efficiently, at the peak of its power curve.

The primary clutch is engine speed sensitive, and is mounted on the engine crankshaft. It operates on the principle of centrifugal force. The secondary clutch, mounted on the transaxle input shaft, is load sensitive to the rear drive wheels.

The primary clutch spins with the engine crankshaft, and centrifugal force on cam weights within the primary clutch tends to close the movable and stationary sheave faces together, while a primary clutch coil spring urges the sheave faces apart. At idle speed the centrifugal force is not enough to overcome force from the spring. The primary clutch split sheave remains opened wide and does not engage the drive belt.

At a minimum load, the primary clutch sheave faces are moved closer together, and start to move the drive belt. The drive belt wraps a maximum race circumference of the secondary clutch. A high CVT turn ratio between the clutches exists, similar to a low gear operation, as long as there is minimal load. The CVT turn ratio is the ratio of the number of turns of the engine output shaft that turns the primary clutch to the number of turns of the transaxle input shaft that is turned by the secondary clutch.

As engine speed increases, centrifugal forces of cam weights force the primary clutch to “up-shift”, moving the sheave faces together and forcing the drive belt to an outer race circumference. The belt overcomes force from a secondary clutch spring that is arranged to urge the movable and stationary sheave faces of the secondary clutch together, wherein the drive belt is pulled deep in the secondary clutch, wrapping a minimum race circumference, resulting in a low CVT ratio, similar to a high gear operation.

Down-shifting occurs as a load is encountered, such as a hill or soft terrain. Turning of a stationary sheave face of the secondary clutch is resisted by the load on the wheels via the transaxle, and at the same time, torque from the drive belt moves a moveable sheave face of the secondary clutch up a ramp that is fixed to turn with the stationary sheave face. The ramp and spring force the movable and stationary sheave faces together which forces the belt to wrap an increased circumference of the secondary clutch. The belt overcomes centrifugal forces of the primary clutch, thus wrapping a decreased circumference of the primary clutch, causing the down-shifting.

The vehicle drivetrain is operable over a total gear ratio that is defined by:

CVT turn ratio×transaxle turn ratio=total gear ratio.

The CVT turn ratio is the ratio of the number of turns of the engine output shaft to the number of turns of the transaxle input shaft. Stated in another way, the CVT turn ratio is the ratio of the rotary speed of the engine output shaft to the rotary speed of the transaxle input shaft. The transaxle turn ratio is typically a fixed ratio of the number of turns of the transaxle input shaft divided by the number of turns of the transaxle output shaft. Stated in another way, the transaxle turn ratio is the ratio of the rotary speed of the transaxle input shaft to the rotary speed of the transaxle output shaft.

In the heretofore known John Deere GATOR® 4×2, the transaxle turn ratio is fixed at 15.28 and the CVT turn ratio is continuously variable with a maximum CVT turn ratio of 4.2 and a minimum CVT turn ratio of 0.94. The transaxle turn ratio is about 3.6 times the maximum CVT turn ratio. The transaxle turn ratio is about 16.2 times the minimum CVT turn ratio.

### SUMMARY OF THE INVENTION

The invention provides a cart-type utility vehicle that incorporates a combination of a continuously variable transmission and a transaxle having a preselected total gear ratio that produces an exemplary tractive force or pulling force while also allowing an acceptable vehicle top speed especially for a relatively lightweight, economically manufactured vehicle.

The invention provides a cart-type utility vehicle having a drivetrain including an engine driving a continuously variable transmission (CVT) that drives a transaxle that drives at least one wheel. The continuously variable transmission has a CVT turn ratio defined as an engine output rotary speed into the CVT divided by a CVT output rotary speed into the transaxle. The transaxle has a transaxle turn ratio defined as the CVT output rotary speed divided by a transaxle output rotary speed to the at least one wheel.

According to an exemplary embodiment of the invention, the transaxle turn ratio is considerably greater than heretofore known comparable utility vehicles. The transaxle turn ratio can be greater than five times the maximum CVT turn ratio. The transaxle turn ratio can be greater than twenty times the minimum CVT turn ratio. The transaxle turn ratio can be greater than 17.

According to an exemplary embodiment of the invention the CVT turn ratio is variable from between about 3 to about 0.8 and the transaxle turn ratio is about 18.

A total gear ratio is the CVT turn ratio of the continuously variable transmission multiplied by the turn ratio of the transaxle. According to an exemplary embodiment of the invention, the difference between the maximum total gear ratio and the minimum total gear ratio is about 40 or greater. According to an exemplary embodiment of the invention, a maximum torque produced by the vehicle drivetrain corresponds to a total gear ratio of about 57, an engine rotary speed of about 2517, and an axle rotary speed of about 43.

A particular exemplary embodiment of the invention provides a continuously variable transmission having a CVT turn ratio of about 0.77 to 3.1 and a transaxle with a transaxle turn ratio of 18.35. These ratios, when multiplied, result in a maximum total gear ratio of about 57 and a minimum total gear ratio of about 14. The difference between the maximum total gear ratio and the minimum total gear ratio is about 43. The transaxle turn ratio is about 6 times the maximum CVT turn ratio. The transaxle turn ratio is about 24 times the minimum CVT turn ratio.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a side view of a utility vehicle incorporating the present invention;

FIG. 2 is a side view of a powertrain that drives the vehicle of FIG. 1;

FIG. 3 is a schematic top view of a continuously variable transmission according to the invention in a maximum torque mode;

FIG. 4 is a schematic side view of the transmission of FIG. 3;

FIG. 5 is schematic top view of the continuously variable transmission of FIG. 3 shown in a maximum speed mode;

FIG. 6 is a schematic side view of the transmission of FIG. 5;

FIG. 7A is a fragmentary top half sectional view of an engine driven split sheave of the transmission taken generally along line 7A-7A of FIG. 3;

FIG. 7B is a fragmentary bottom half sectional view of the engine driven split sheave of the transmission taken generally along line 7B-7B of FIG. 5;

FIG. 8A is a fragmentary top half sectional view of a transaxle-driving split sheave of the transmission taken generally along line 8A-8A of FIG. 3;

FIG. 8B is a fragmentary bottom half sectional view of a transaxle-driving split sheave of the transmission taken generally along line 8B-8B of FIG. 5;

FIG. 8C is a schematical fragmentary plan view of a portion of the transaxle-driving split sheave shown in FIG. 8B; and

FIG. 9 is a schematic sectional view of a transaxle.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

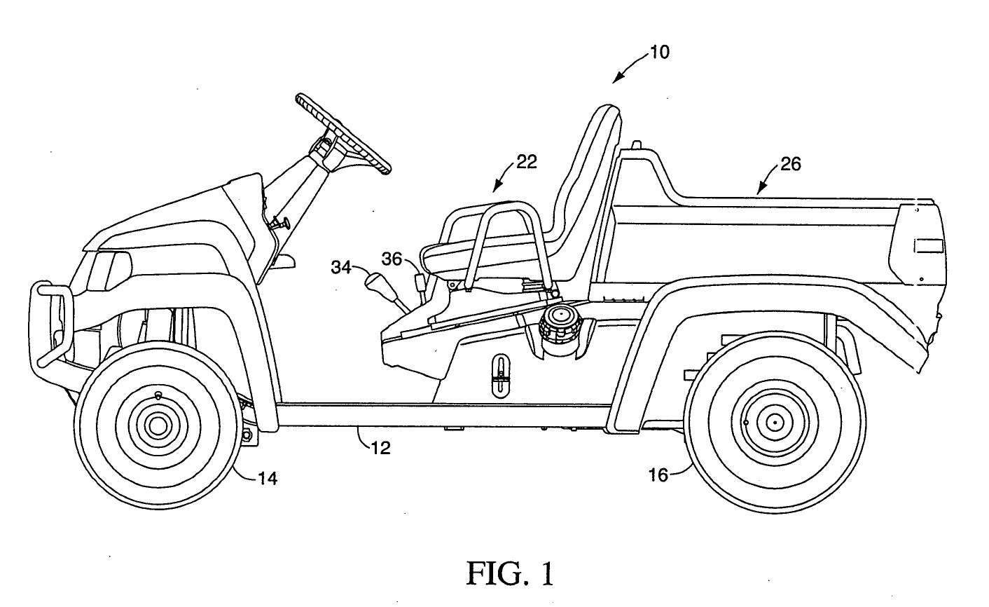

FIG. 1 illustrates a utility vehicle 10 that incorporates the present invention. The vehicle 10 includes a frame 12 carried by front wheels 14 and rear wheels 16. The vehicle 10 includes a driver's station 22 and a cargo area 26.

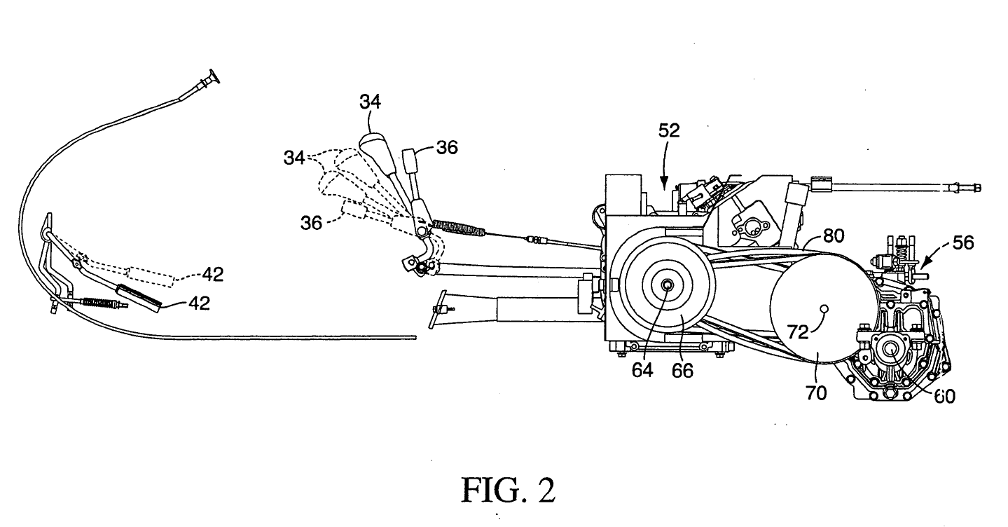

FIG. 2 illustrates a drive train 32 for the vehicle 10 that is partially hidden in FIG. 1. The drive train includes a directional shifter 34 and a differential lock lever 36.

An accelerator pedal 42 is located in the footwell of the vehicle. An engine 52 is mounted in front of a transaxle 56 that drives a rear axle 60 operatively connected to the rear wheels 16.

An engine output shaft 64 is fixed to an engine driven primary clutch in the form of a split sheave 66. A transaxle-driving secondary clutch in the form of a split sheave 70 is fixed to a transaxle input shaft 72.

The sheaves 66, 70 each provide a variable depth belt race. A belt 80 encircles the shafts 64, 72 within the races of the sheaves 66, 70.

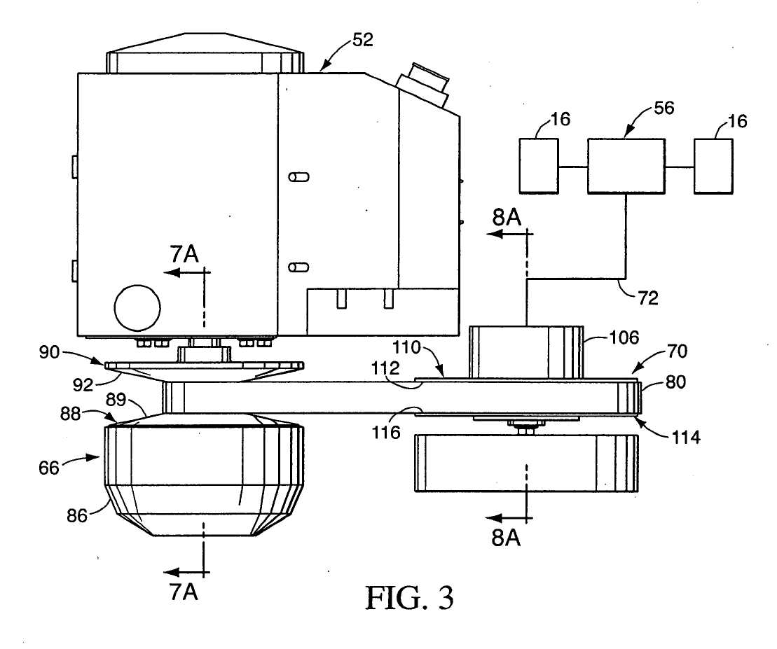

FIG. 3 illustrates the sheave 66 including an actuator 86 that carries a movable plate 88 having a movable face 89, and a fixed plate 90 that includes a fixed face 92. A V-shaped sheave race 94 is defined between the faces 89, 92.

The transaxle-driving sheave 70 includes an actuator 106 that carries a movable plate 110 having a movable face 112, and a fixed plate 114 having a fixed face 116. A V-shaped sheave race 120 is defined between the faces 112, 116.

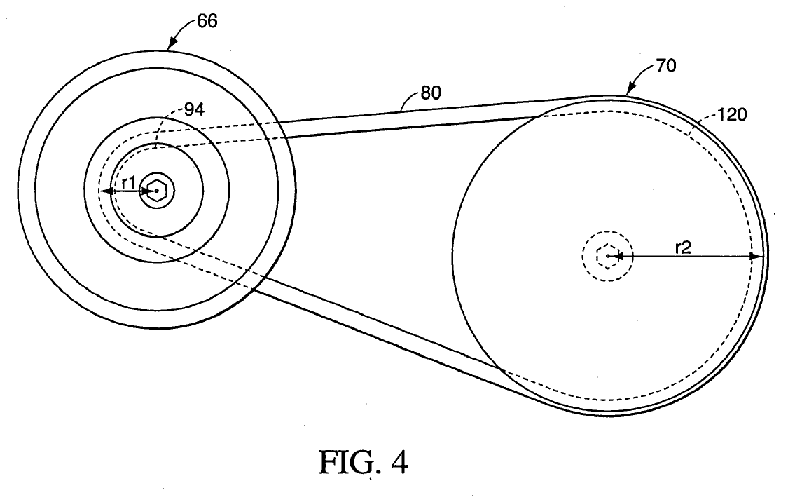

FIG. 4 illustrates the transmission in a maximum torque mode wherein a radius r1 of the race 94 is a minimum and a radius r2 of the race 120 is maximum. According to an exemplary embodiment of the invention r2/r1=3.1.

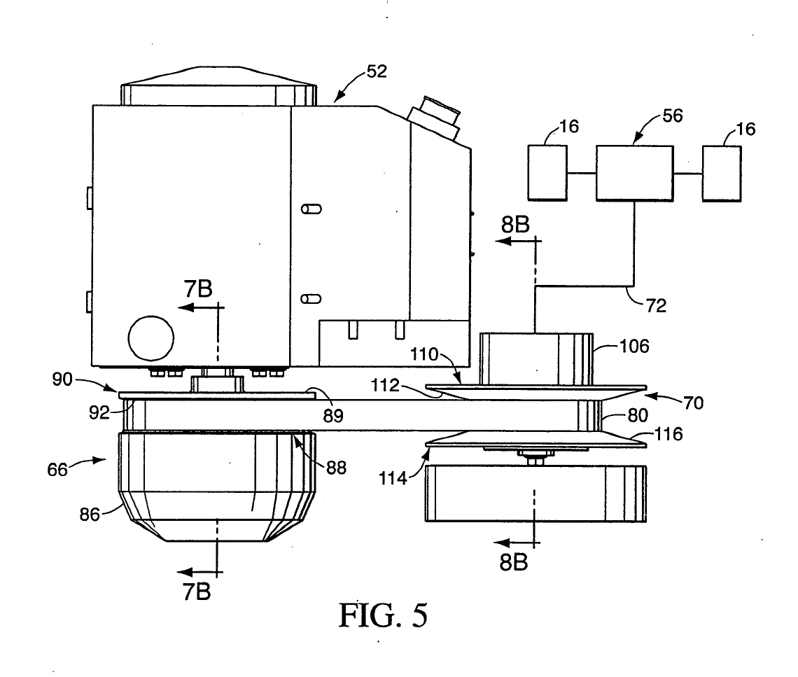

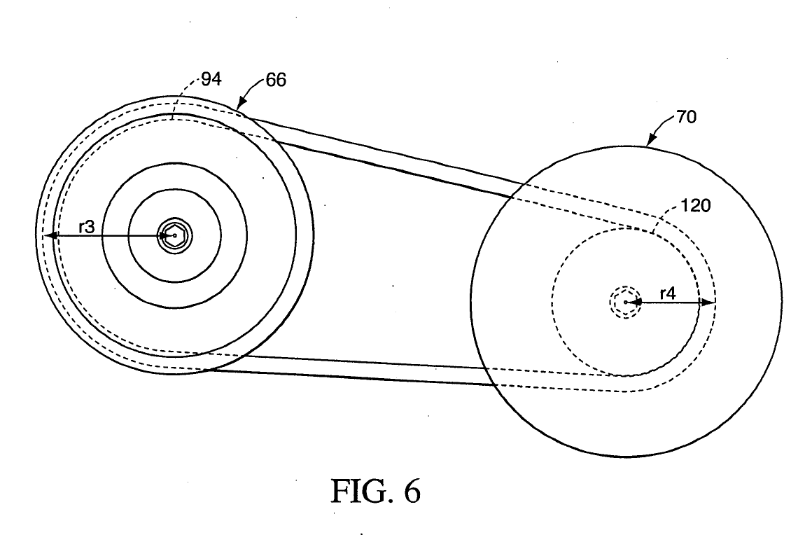

FIGS. 5 and 6 illustrate the transmission in a maximum speed mode wherein a radius of the race 94 is r3 and a radius of the race 120 is r4. According to an exemplary embodiment of the invention r4/r3=0.77.

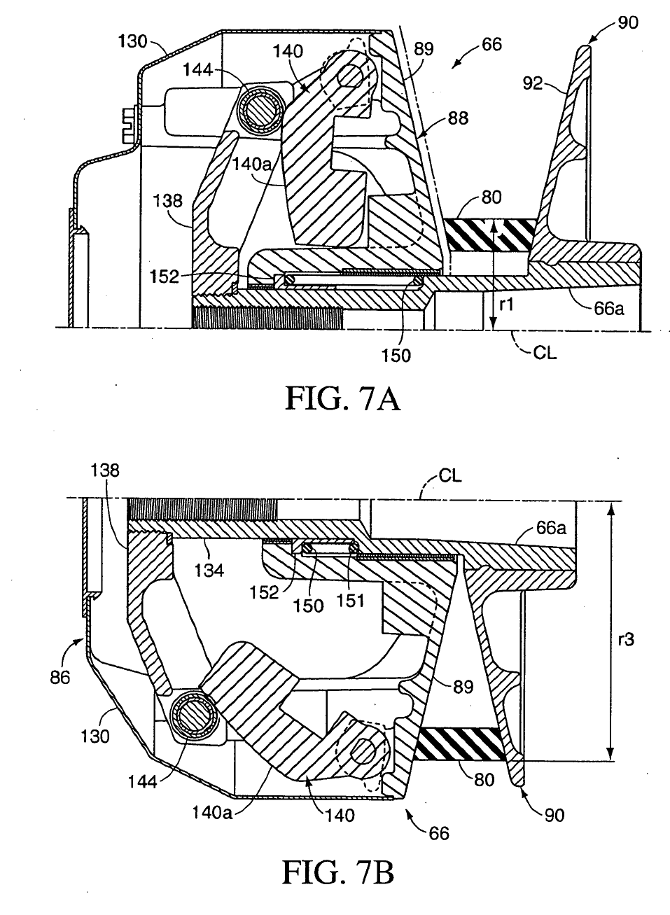

FIGS. 7A and 7B illustrate the primary clutch 66 to be mounted on the engine output shaft 64. The centerline thereof is indicated as CL. An internal bore 66a is configured to be fixedly coupled to the shaft 64 to rotate therewith. The clutch 66 includes a housing 130. The fixed sheave plate 92 includes a spindle 134 that enters the housing 130 and is fixed to a backing plate 138 within the housing 130. The movable sheave plate 88 includes a plurality of cam weights 140 that are pivotally connected to a backside of the movable sheave plate 88 and have the cam surfaces 140a that are pressed against pins 144 which are mounted to the backing plate 138. A coil spring 150 is located surrounding the spindle 134 and between a shoulder 151 of the spindle 134 and a shoulder 152 of the movable sheave plate 88. The spring 150 urges the movable sheave plate face 89 away from the fixed sheave plate face 92.

The clutch 66 operates on the principle of centrifugal force and is engine speed sensitive. At idle speed, the primary clutch 66 spins with the engine output shaft 64, but centrifugal force on the weights 140 is not enough to overcome the force of primary clutch spring 151. The primary clutch sheave remains opened wide and does not engage the drive belt 80.

As shown in FIG. 7A, at a minimum load, the primary clutch sheave plate faces 89, 92 are moved closer together, by centrifugal force of the cam weights 140 against the pins 144. The sheave plates 88, 90 start to circulate the drive belt 80 at a minimum wrapped race circumference of the clutch 66. The drive belt 80 wraps a maximum race circumference of the secondary clutch. A high ratio between the clutches exists, similar to a low gear operation, as long as there is minimal load.

As shown in FIG. 7B, as engine speed increases, centrifugal forces of the cam weights 140 force the primary clutch to “up-shift”, moving the drive belt to an increasing race circumference. The belt overcomes force from a secondary clutch spring 174 (described below), wherein the drive belt 80 is pulled deep in the secondary clutch 70, wrapping a decreasing race circumference and giving a low ratio, similar to a high gear operation.

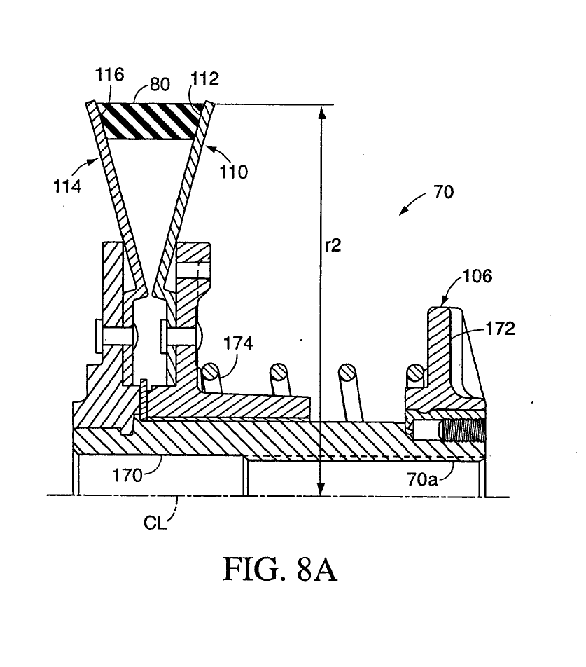

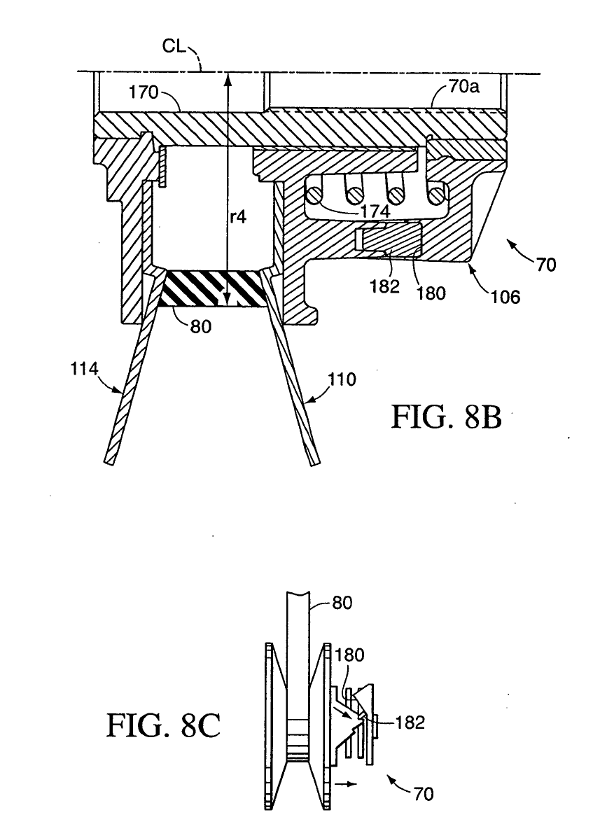

FIGS. 8A and 8B illustrate the secondary clutch 70. The centerline thereof is indicated as CL. An internal bore 70a is configured to be fixedly coupled to the transaxle input shaft 72 to rotate therewith. The stationary clutch includes a spindle 170 connected to the fixed sheave plate 114. A spindle 170 is connected to a backing plate 172. A coil spring 174 is arranged surrounding the spindle 170 between the backing plate 172 and the movable sheave plate 110. The spring 174 urges the movable sheave plate face 112 toward the stationary sheave plate face 116. The backing plate 172 includes one or more ramps 180 and the movable sheave plate includes one or more protrusions 182 which ride on the ramp(s) 180 (see FIG. 8C). The protrusion(s) 182 can be in the form of plastic replaceable buttons.

The secondary clutch 70 is load sensitive to the rear drive wheels 16. Down-shifting occurs as a load is encountered, such as a hill or soft terrain. The load on the wheels is transmitted to the stationary sheave plate 114 of the secondary clutch through the transaxle, and at the same time, torque from the drive belt 80 moves the moveable sheave plate 110 of the secondary clutch up the ramp 180. The ramp 180 and spring 174 forces the faces 112, 116 closer together and the belt 80 to wrap an increased circumference of the secondary clutch (FIG. 8A). The secondary clutch 70 overcomes centrifugal forces of the primary clutch cam weights 140, thus causing a wrapping of a decreased circumference of the primary clutch, which causes the down-shifting.

Primary and secondary clutches of the type described above are commercially available from suppliers such as Hoffco-Comet Industries, Incorporated of Richmond, Ind., U.S.A as models 72C and 88D. Examples of primary and secondary clutches are disclosed in U.S. Pat. Nos. 5,647,810; 5,597,060 and 5,967,286, herein incorporated by reference.

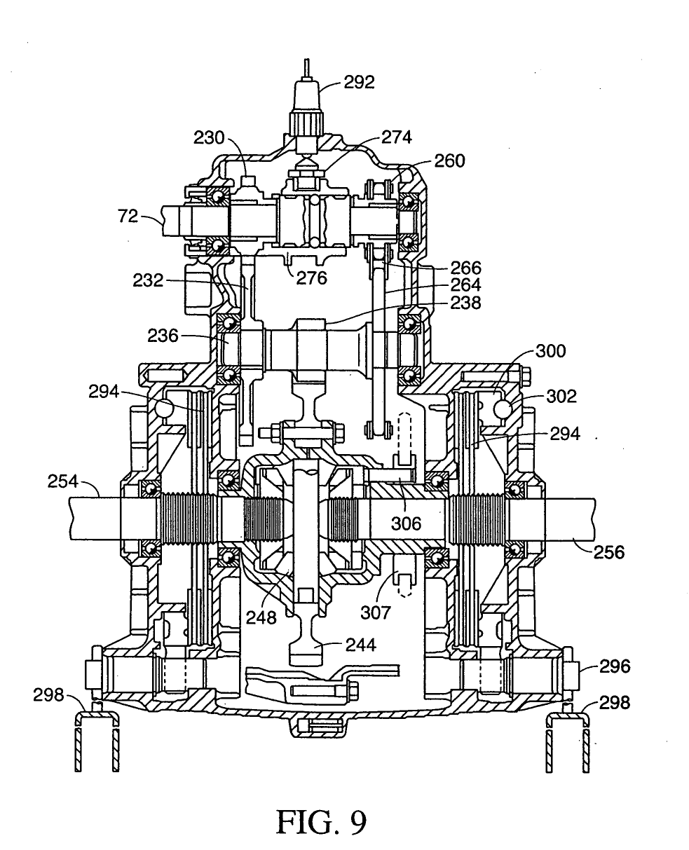

FIG. 9 illustrates, in schematic fashion, a typical transaxle 56. The transaxle 56 includes the input shaft 72, a forward drive gear 230 connected thereto, and a forward driven gear 232 that is enmesh with the forward drive gear 230 and fixed to a reduction gear shaft 236. A reduction drive gear 238 is fixed on the gear shaft 236 and enmesh with a differential gear 244. The differential gear 244 drives differential pinion gears 248. The pinion gears 248 drive left and right output shafts 254, 256, that drive the wheels 16.

A reverse drive sprocket 260 and a reverse driven sprocket 264 are coupled by a reverse drive chain 266 and are provided for driving the transaxle in reverse. A shift fork 274 and an input shaft 276 are operatively connected to the directional shifter 34 and are used to select between forward and reverse operation.

The transaxle 56 also includes a neutral switch 292, brake disks and plates 294, a brake shaft 296, brake levers 298, a brake actuator plate 300, a ball and ramp arrangement 302, a differential lock pin 306, and a differential lock collar 307 all arranged and configured in a conventional manner.

According to an exemplary embodiment of the invention, the size and number of teeth of the gears 230, 232, 238, 244, 248 are selected such that the number of turns of the input shaft 72 is about 18, in particular 18.35, times the number of turns of the output shafts 254 or 256. A transaxle so configured may be commercially available from Kanzaki Kokyukoki Mfg. Co. Ltd. Of Amagasaki, Hyogo, Japan, as Model AM 131715 or from Transaxle Manufacturing of America Corporation, Rockhill, S.C., as Model AM132333. An alternate transaxle having a transaxle turn ratio of 19.2 to 1 can be obtained from Dana Corporation, Off Highway Systems (Components) Group, Maumee, Ohio, U.S., Model H12.

An exemplary embodiment utility vehicle of the invention has the following specifications:

Vehicle weight 650 lbs.

Maximum payload 800 lbs.

Rolling radius (20 inch tires) 0.75 ft

Gross weight with no cargo or operator 1450 lbs.

Maximum Torque Operation

Engine RPM 2517

Engine torque 13.73 ft-lbs.

Primary clutch pitch diameter 2.64 in.

Secondary clutch pitch diameter 8.3 in.

CVT ratio 3.14

Transaxle (T/A) ratio 18.35

Total ratio CVT ratio×T/A ratio 57.6

Input shaft torque 43.17 ft-lbs.

Axle torque 791 ft-lbs.

Axle speed 43 RPM

Vehicle speed 2.4 mph

Vehicle tractive force (Torque/R) 1054 lbs.

Force to weight ratio 0.73

Force to weight ratio (operator only) 1.24

Maximum Speed Operation

Engine RPM 3750

Engine torque 10.6 ft-lbs.

Primary clutch pitch diameter 6.36 in.

Secondary clutch pitch diameter 4.88 in.

CVT ratio 0.77

Transaxle (T/A) ratio 18.35

Total ratio CVT ratio×T/A ratio 14.13

Input shaft torque 8.2 ft-lbs.

Axle torque 150 ft-lbs.

Axle speed 265 RPM

Vehicle speed 14.0 mph

Vehicle tractive force (Torque/R) 200 lbs.

Force to weight ratio 0.14 Force to weight ratio (operator only) 0.24

The exemplary embodiment of the invention provides a continuously variable transmission having a CVT turn ratio of about 0.77 to 3.1 and a transaxle with a transaxle turn ratio of about 18.35. These ratios, when multiplied, result in a maximum total gear ratio of about 58 and a minimum total gear ratio of about 14. The difference between the maximum total gear ratio and the minimum total gear ratio is about 44. The transaxle turn ratio is about 6 times the maximum CVT turn ratio. The transaxle turn ratio is about 24 times the minimum CVT turn ratio.

Another exemplary embodiment would have a CVT ratio of between 0.59 and 3.1 and a transaxle ratio of about 24 for a total gear ratio of between about 14 and 74. The difference between the maximum total gear ratio and the minimum total gear ratio is about 60. The transaxle turn ratio is about 7.7 times the maximum CVT turn ratio. The transaxle turn ratio is about 41 times the minimum CVT turn ratio. The transaxle is commercially available from Dana Corporation, Off Highway Systems (Components) Group, Maumee, Ohio, U.S.

From the foregoing, it will be observed that numerous variations and modifications may be effected without departing from the spirit and scope of the invention. It is to be understood that no limitation with respect to the specific apparatus illustrated herein is intended or should be inferred.

1. In a small utility cart having a drivetrain including an engine that has an engine rotary output that drives a continuously variable transmission (CVT) that has a CVT rotary output that drives a transaxle that has a transaxle rotary output that drives at least one wheel, the continuously variable transmission having a CVT turn ratio defined as an engine rotary output speed divided by a CVT rotary output speed, and the transaxle having a transaxle turn ratio defined as the CVT rotary output speed divided by a transaxle rotary output speed, the improvement comprising:
the transaxle turn ratio being greater than five times the maximum CVT turn ratio.

2. The improvement according to claim 1, wherein the transaxle turn ratio is greater than twenty times the minimum CVT turn ratio.

3. The improvement according to claim 1, wherein a total gear ratio is the CVT turn ratio multiplied by the transaxle turn ratio, and the difference between the maximum total gear ratio and the minimum total gear ratio is about 40 or greater.

4. The improvement according to claim 1, wherein a total gear ratio is the CVT turn ratio multiplied by the transaxle turn ratio, and wherein a maximum torque produced by the vehicle drivetrain corresponds to a total gear ratio of about 58, an engine rotary speed of about 1500, and an axle rotary speed of about 26.

5. The improvement according to claim 1, wherein the transaxle turn ratio is about 18.

6. In a small utility cart having a drivetrain including an engine that has an engine rotary output that drives a continuously variable transmission (CVT) that has a CVT rotary output that drives a transaxle that has a transaxle rotary output that drives at least one wheel, the continuously variable transmission having a CVT turn ratio defined as an engine rotary output speed divided by a CVT rotary output speed, and the transaxle having a transaxle turn ratio defined as the CVT rotary output speed divided by a transaxle rotary output speed, the improvement comprising:
the maximum transaxle turn ratio being greater than 17.

7. The improvement according to claim 6, wherein a total gear ratio is the CVT turn ratio multiplied by the transaxle turn ratio, and the difference between the maximum total gear ratio and the minimum total gear ratio is about 40 or greater.

8. The improvement according to claim 6, wherein a total gear ratio is the CVT turn ratio multiplied by the transaxle turn ratio, and wherein a maximum torque produced by the vehicle drivetrain corresponds to a total gear ratio of about 58, an engine rotary speed of about 1500, and an axle rotary speed of about 26.

9. The improvement according to claim 6, wherein the transaxle turn ratio is greater than five times the maximum CVT turn ratio, and wherein the transaxle turn ratio is greater than twenty times the minimum CVT turn ratio.

10. The improvement according to claim 6, wherein the transaxle turn ratio is about 18.

11. In a small utility cart having a drivetrain including an engine that has an engine rotary output that drives a continuously variable transmission (CVT) that has a CVT rotary output that drives a transaxle that has a transaxle rotary output that drives at least one wheel, the continuously variable transmission having a CVT turn ratio defined as an engine rotary output speed divided by a CVT rotary output speed, and the transaxle having a transaxle turn ratio defined as the CVT rotary output speed divided by a transaxle rotary output speed, the improvement comprising:
the transaxle turn ratio being greater than five times the maximum CVT turn ratio;
the transaxle turn ratio is greater than twenty times the minimum CVT turn ratio;
wherein a total gear ratio is the CVT turn ratio multiplied by the transaxle turn ratio, and the difference between the maximum total gear ratio and the minimum total gear ratio is about 40 or greater.
